(19) United States
(12) Patent Application Publication
(10) Pub. No.: US 2025/0273908 A1
(43) Pub. Date: Aug. 28, 2025

(54) Female Connector

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/062,300

(22) Filed: Feb. 25, 2025

(30) Foreign Application Priority Data
Feb. 26, 2024 (TW) 113201958

(51) Int. Cl. H01R 13/64; H01R 13/629

(52) U.S. Cl. CPC H01R 13/64; H01R 13/629

(57) ABSTRACT

A female connector, wherein the female connector is provided to allow insertion of a male connector in the inserting direction. The insulation core of the female connector comprises an inserting guiding structure, which provides interference when the male connector is inserted in an incorrect inserting direction to prevent incorrect insertion of the male connector into the female connector, thereby enabling the male connector to be inserted into the female connector for power or signal transmission.

### CROSS-REFERENCE TO RELATED APPLICATIONS

This application claims the priority of Republic of China Patent Application No. 113201958 filed on Feb. 26, 2024, in the State Intellectual Property Office of the R.O.C., the disclosure of which is incorporated herein by reference.

### BACKGROUND OF THE INVENTION

### Field of the Invention

This application relates to signal transmission technology, and more specifically, to a female connector that can prevent incorrect inserting direction of a male connector.

### Descriptions of the Related Art

In electrical equipment, it is often necessary to transmit electrical signals through a connector assembly composed of a female connector and a male connector. During the implementation of the connector assembly, the male connector can be inserted into the female connector to provide electrical signal transmission for the electrical equipment.

However, the inserting of the male connector into the female connector is usually directional. If the inserting direction of the male connector is incorrect, the electrical signal transmission of the connector assembly may suffer from voltage mismatches and other issues, thereby causing the electrical equipment to malfunction.

Therefore, how to provide a female connector that prevents incorrect inserting direction of the male connector is indeed an urgent problem to be solved by those skilled in the relevant technical field.

### SUMMARY OF THE INVENTION

In view of the drawbacks of the prior art mentioned above, the present application provides a female connector, wherein the female connector provides inserting of a male connector in an inserting direction, and the female connector comprises: a female conductive terminal set, wherein the female conductive terminal set comprises a first female terminal, a second female terminal, a third female terminal, and a fourth female terminal; and a female insulation core, wherein the female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein, the first female core lateral outer wall and the second female core lateral outer wall laterally extend respectively, and the first female core longitudinal outer wall and the second female core longitudinal outer wall longitudinally extend respectively; the first female core longitudinal outer wall is connected to the first female core lateral outer wall, and the second female core longitudinal outer wall is connected to the second female core lateral outer wall, to form a female core major internal inserting space; the first female core lateral inner wall and the second female core lateral inner wall laterally extend respectively, wherein the first female core lateral inner wall is connected to the first female core longitudinal outer wall to form a first female major inserting guiding structure, and the first female core longitudinal inner wall is connected to the second female core lateral inner wall and the first female core lateral outer wall respectively to form a second female major inserting guiding structure; wherein, the first female major inserting guiding structure and the second female major inserting guiding structure partition the female core major internal inserting space into a first female major internal inserting subspace, a second female major internal inserting subspace, a third female major internal inserting subspace, and a fourth female major internal inserting subspace; the female insulation core is respectively mated with the first female terminal, the second female terminal, the third female terminal, and the fourth female terminal, such that the first female terminal extends into the first female major internal inserting subspace, the second female terminal extends into the second female major internal inserting subspace, the third female terminal extends into the third female major internal inserting subspace, and the fourth female terminal extends into the fourth female major internal inserting subspace; and the first female major internal inserting subspace is in continuity with the second female major internal inserting subspace, the second female major internal inserting subspace is in continuity with the fourth female major internal inserting subspace, and the third female major internal inserting subspace is in continuity with the fourth female major internal inserting subspace to provide guiding for inserting of the male connector in the inserting direction, such that the male connector enters the first female major internal inserting subspace, the second female major internal inserting subspace, the third female major internal inserting subspace, and the fourth female major internal inserting subspace respectively, thereby respectively inserting into the first female terminal, the second female terminal, the third female terminal, and the fourth female terminal.

Preferably, the female connector said above, wherein the first female major inserting guiding structure comprises a T-shaped cross-section; and the second female major inserting guiding structure comprises an L-shaped cross-section.

Preferably, the female connector said above, wherein the first female core lateral inner wall and the first female core longitudinal outer wall substantially intersect perpendicularly, and the second female core lateral inner wall and the first female core longitudinal inner wall substantially intersect perpendicularly.

Preferably, the female connector said above, wherein the female insulation core comprises a lateral extension plane, the first female core lateral inner wall and the second female core lateral inner wall extend respectively on the lateral extension plane, and the lateral extension plane substantially intersects perpendicularly with the first female core longitudinal outer wall and the first female core longitudinal inner wall.

Preferably, the female connector said above, wherein the female conductive terminal set further comprises a fifth female terminal and a sixth female terminal, and the female insulation core further comprises a third female core longitudinal outer wall and a third female core lateral inner wall, wherein the third female core longitudinal outer wall longitudinally extends and is respectively connected to the first female core lateral outer wall and the second female core lateral outer wall, such that the second female core longitudinal outer wall, the third female core longitudinal outer wall, the first female core lateral outer wall, and the second female core lateral outer wall form a female core minor internal inserting space; the third female core lateral inner wall is connected to the second female core longitudinal outer wall or the third female core longitudinal outer wall to form a first female minor inserting guiding structure; wherein, the first female minor inserting guiding structure partitions the female core minor internal inserting space into a first female minor internal inserting subspace and a second female minor internal inserting subspace; the female insulation core is further mated with the fifth female terminal and the sixth female terminal, such that the fifth female terminal extends into the first female minor internal inserting subspace, and the sixth female terminal extends into the second female minor internal inserting subspace; and the first female minor internal inserting subspace is in continuity with the second female minor internal inserting subspace to provide guiding for inserting of the male connector in the inserting direction, such that the male connector enters the first female minor internal inserting subspace and the second female minor internal inserting subspace respectively, thereby respectively inserting into the fifth female terminal and the sixth female terminal.

Preferably, the female connector said above, wherein the first female minor inserting guiding structure comprises a T-shaped cross-section.

Preferably, the female connector said above, wherein the third female core lateral inner wall and the second female core longitudinal outer wall or the third female core longitudinal outer wall substantially intersect perpendicularly.

Preferably, the female connector said above, wherein the female insulation core comprises a lateral extension plane, the first female core lateral inner wall, the second female core lateral inner wall, and the third female core lateral inner wall extend respectively on the lateral extension plane, and the lateral extension plane substantially intersects perpendicularly with the first female core longitudinal outer wall, the first female core longitudinal inner wall, the second female core longitudinal outer wall, and the third female core longitudinal outer wall.

Compared to the prior art, this application provides a female connector, which allows a male connector to be inserted in the inserting direction. The insulation core of the female connector comprises an inserting guiding structure, which provides interference when the male connector is inserted in the wrong inserting direction. This prevents the male connector from being inserted into the female connector in the wrong direction, ensuring proper insertion and enabling the transmission of power or signals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the female connector of the present application in an embodiment.

FIG. 2 is a top schematic view of the female connector of the present application in an embodiment.

FIG. 3 is a top schematic view of the female connector of the present application in an embodiment.

FIG. 4 is a top schematic view of the female connector of the present application in an embodiment.

FIG. 5 is a sectional schematic view of a portion of the female connector shown in FIG. 2, taken along line AA.

FIG. 6 is a sectional schematic view of a portion of the female connector shown in FIG. 2, taken along line BB.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

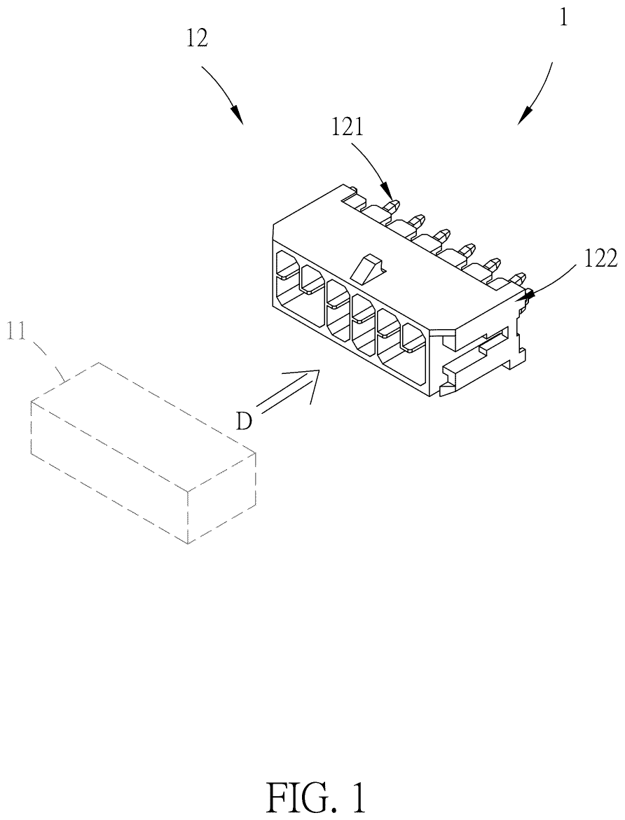

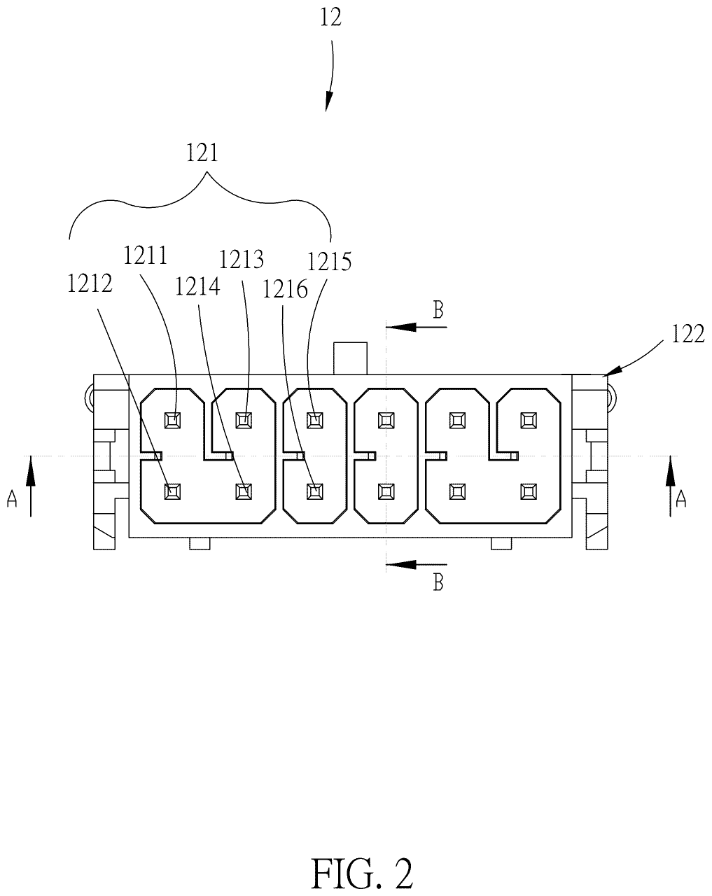

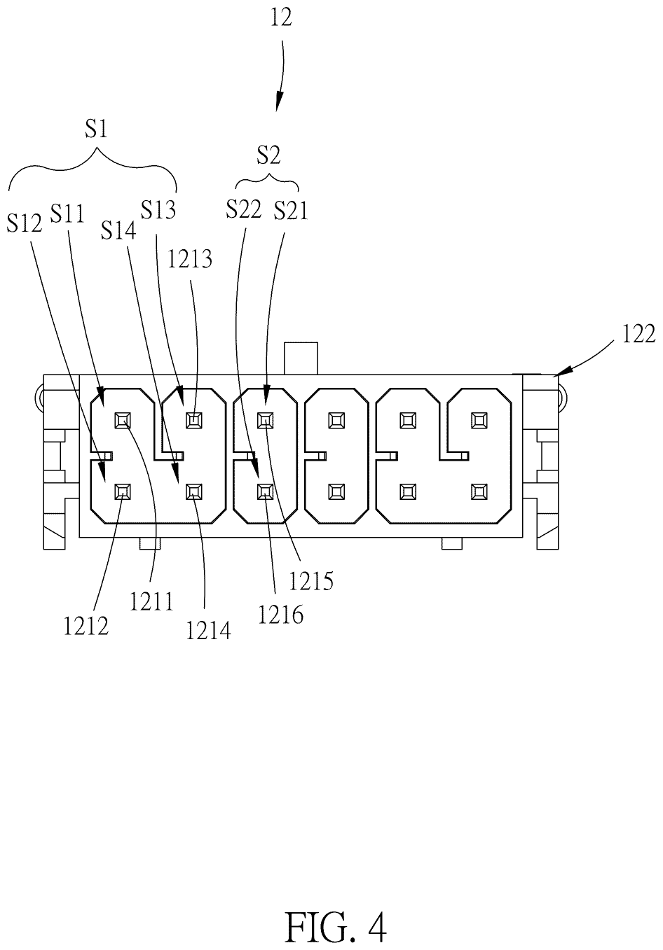

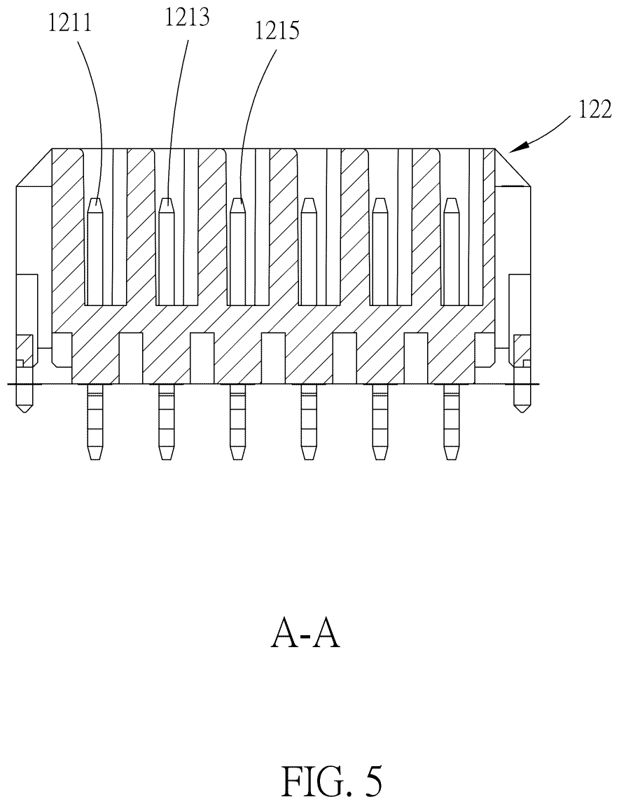

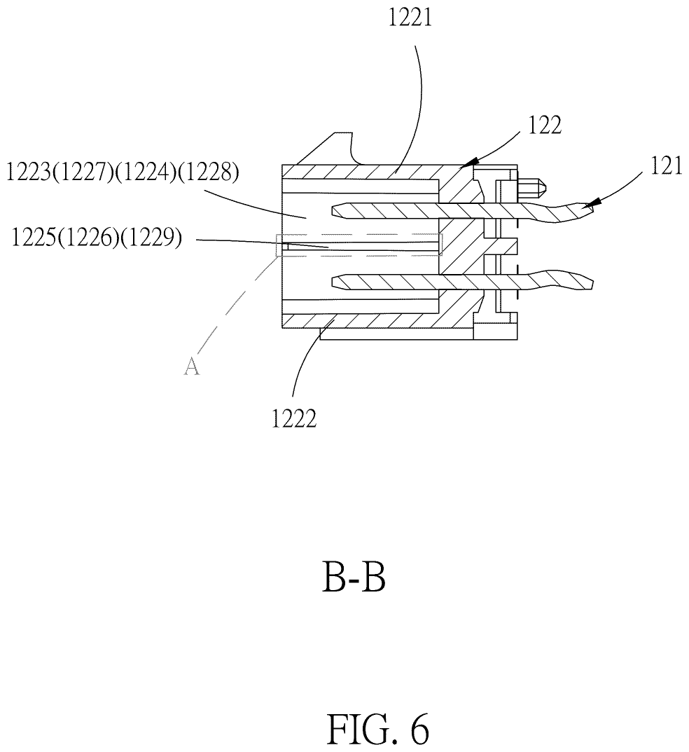

For a detailed description of the embodiments disclosed in the present application, please refer to FIGS. 1 to 6.

The present application provides at least one connector assembly 1 that can be installed in electrical equipment, wherein the connector assembly 1 comprises a male connector 11 and a female connector 12. The male connector 11 can be inserted into the female connector 12 in an inserting direction D to provide power or signal transmission for the electrical equipment.

In the embodiments shown in FIGS. 1, 2, 4, and 6, the female connector 12 comprises a female conductive terminal set 121 and a female insulation core 122. The female conductive terminal set 121 comprises a first female terminal 1211, a second female terminal 1212, a third female terminal 1213, a fourth female terminal 1214, a fifth female terminal 1215, and a sixth female terminal 1216, which provide power or signal transmission. The female insulation core 122 comprises a first female core lateral outer wall 1221, a second female core lateral outer wall 1222, a first female core longitudinal outer wall 1223, a second female core longitudinal outer wall 1224, a first female core lateral inner wall 1225, a second female core lateral inner wall 1226, a first female core longitudinal inner wall 1227, a third female core longitudinal outer wall 1228, and a third female core lateral inner wall 1229.

In the above embodiment, the first female core lateral outer wall 1221 and the second female core lateral outer wall 1222 extend laterally, while the first female core longitudinal outer wall 1223, the second female core longitudinal outer wall 1224, and the third female core longitudinal outer wall 1228 extend longitudinally. The first female core lateral inner wall 1225, the second female core lateral inner wall 1226, and the third female core lateral inner wall 1229 also extend laterally.

Furthermore, the first female core longitudinal outer wall 1223 is connected to the first female core lateral outer wall 1221, and the second female core longitudinal outer wall 1224 is connected to the second female core lateral outer wall 1222, forming a female core major internal inserting space S1 with the first female core longitudinal outer wall 1223, the second female core longitudinal outer wall 1224, the first female core lateral outer wall 1221, and the second female core lateral outer wall 1222. The third female core longitudinal outer wall 1228 is respectively connected to the first female core lateral outer wall 1221 and the second female core lateral outer wall 1222, forming a female core minor internal inserting space S2 with the second female core longitudinal outer wall 1224, the third female core longitudinal outer wall 1228, the first female core lateral outer wall 1221, and the second female core lateral outer wall 1222.

It should be noted that the male connector 11 can be inserted into the female connector 12 in the female core major internal inserting space S1 and the female core minor internal inserting space S2.

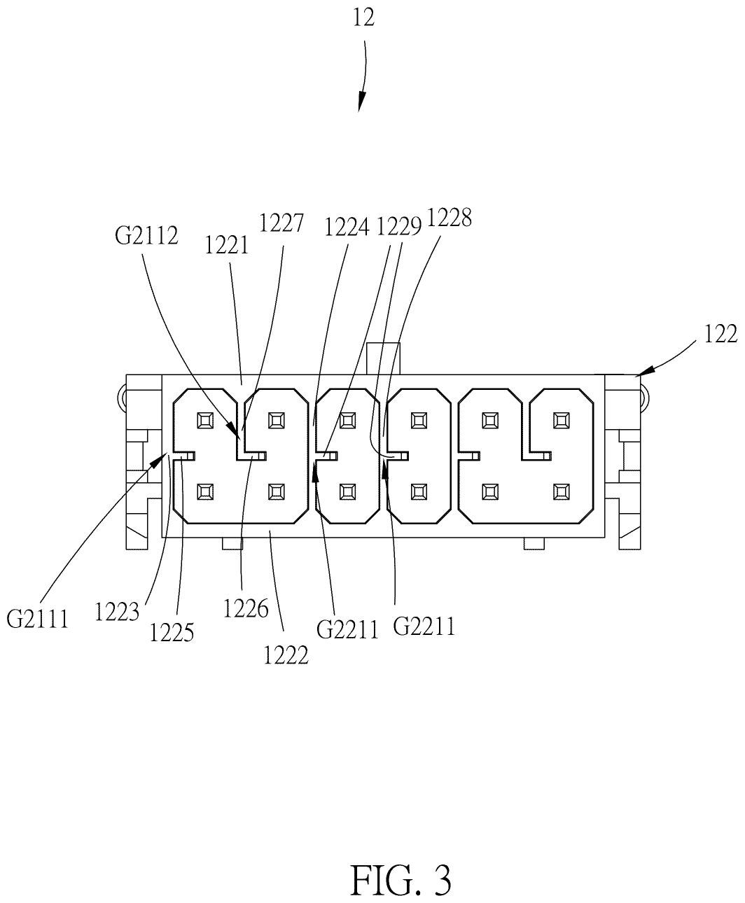

Additionally, the first female core lateral inner wall 1225 connects to the first female core longitudinal outer wall 1223, forming a first female major inserting guiding structure G2111. The first female core longitudinal inner wall 1227 connects to the second female core lateral inner wall 1226 and the first female core lateral outer wall 1221, allowing the first female core longitudinal inner wall 1227 and the second female core lateral inner wall 1226 to form a second female major inserting guiding structure G2112. As shown in FIG. 3, the third female core lateral inner wall 1229 connects to the second female core longitudinal outer wall 1224, allowing the third female core lateral inner wall 1229 connects to the second female core longitudinal outer wall 1224 to form a first female minor inserting guiding structure G2211. As shown in FIG. 3, the third female core lateral inner wall 1229 connects to the third female core longitudinal outer wall 1228, allowing the third female core lateral inner wall 1229 connects to the third female core longitudinal outer wall 1228 to form a first female minor inserting guiding structure G2211.

In the above embodiment, through the first female major inserting guiding structure G2111 and the second female major inserting guiding structure G2112, the female core major internal inserting space S1 is divided into a first female major internal inserting subspace S11, a second female major internal inserting subspace S12, a third female major internal inserting subspace S13, and a fourth female major internal inserting subspace S14. The first female major internal inserting subspace S11 is in continuity with the second female major internal inserting subspace S12, and the second female major internal inserting subspace S12 is in continuity with the fourth female major internal inserting subspace S14 to guide the insertion of the male connector 11 in the inserting direction D. Similarly, the third female major internal inserting subspace S13 is in continuity with the fourth female major internal inserting subspace S14 to guide the insertion of the male connector 11 in the inserting direction D. This allows the male connector 11 to be inserted into the female connector 12, respectively entering the first female major internal inserting subspace S11, the second female major internal inserting subspace S12, the third female major internal inserting subspace S13, and the fourth female major internal inserting subspace S14, thereby inserting to the first female terminal 1211, the second female terminal 1212, the third female terminal 1213, and the fourth female terminal 1214 to provide power or signal transmission for electrical equipment.

Furthermore, through the first female minor inserting guiding structure G2211, the female core minor internal inserting space S2 is divided into a first female minor internal inserting subspace S21 and a second female minor internal inserting subspace S22. The first female minor internal inserting subspace S21 is in continuity with the second female minor internal inserting subspace S22 to guide the insertion of the male connector 11 in the inserting direction D. This allows the male connector 11 to be inserted into the female connector 12, respectively entering the first female minor internal inserting subspace S21 and the second female minor internal inserting subspace S22, thereby inserting to the fifth female terminal 1215 and the sixth female terminal 1216 to provide the power or signal transmission for electrical equipment.

The female insulation core 122 is respectively engaged and positioned with the first female terminal 1211, the second female terminal 1212, the third female terminal 1213, the fourth female terminal 1214, the fifth female terminal 1215, and the sixth female terminal 1216, ensuring that the first female terminal 1211, the second female terminal 1212, the third female terminal 1213, the fourth female terminal 1214, the fifth female terminal 1215, and the sixth female terminal 1216 remain separate. Additionally, each terminal extends respectively into the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22.

It should be noted that when the male connector 11 is inserted into the female connector 12 in the inserting direction D, the first female major inserting guiding structure G2111, the second female major inserting guiding structure G2112, and the first female minor inserting guiding structure G2211 provide guidance for the insertion of the male connector 11 in the inserting direction D. This ensures that the male connector 11 respectively enters the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22, respectively inserting the first female terminal 1211, the second female terminal 1212, the third female terminal 1213, the fourth female terminal 1214, the fifth female terminal 1215, and the sixth female terminal 1216, thereby enabling the transmission of power or signals for electrical equipment.

In the embodiment shown in FIG. 3, the first female major inserting guiding structure G2111 comprises a T-shaped cross-section that serves as a mistake-proofing structure; the second female major inserting guiding structure G2112 comprises an L-shaped cross-section that also forms a mistake-proofing structure; and the first female minor inserting guiding structure G2211 comprises a T-shaped cross-section that serves as a mistake-proofing structure. With these mistake-proofing structures, interference is provided when the male connector 11 is inserted incorrectly in the inserting direction D, thereby preventing the male connector 11 from being inserted into the female connector 12 in the wrong direction.

Additionally, in the embodiment shown in FIG. 3, the first female core lateral inner wall 1225 and the first female core longitudinal outer wall 1223 substantially intersect perpendicularly to form a mistake-proofing structure; the second female core lateral inner wall 1226 and the first female core longitudinal inner wall 1227 substantially intersect perpendicularly to form a mistake-proofing structure; and the third female core lateral inner wall 1229 and either the second female core longitudinal outer wall 1224 or the third female core longitudinal outer wall 1228 substantially intersect perpendicularly to form a mistake-proofing structure. With these mistake-proofing structures, interference is provided when the male connector 11 is inserted incorrectly in the inserting direction D, thereby preventing the male connector 11 from being inserted into the female connector 12 in the wrong direction.

Furthermore, the female insulation core 122 comprises a lateral extension plane A. The first female core lateral inner wall 1225, the second female core lateral inner wall 1226, and the second female core lateral inner wall 1226 extend along the lateral extension plane A, forming a mistake-proofing structure. Additionally, the first female core longitudinal outer wall 1223, the first female core longitudinal inner wall 1227, the second female core longitudinal outer wall 1224, and the third female core longitudinal outer wall 1228 substantially intersect perpendicularly with the lateral extension plane A, forming a mistake-proofing structure. With these mistake-proofing structures, interference is provided when the male connector 11 is inserted incorrectly in the inserting direction D, thereby preventing the male connector 11 from being inserted into the female connector 12 in the wrong direction.

It should be noted that some components in the aforementioned embodiments of the connector assembly and the female connector in this application can be omitted. For example, the female connector may optionally comprise only the female conductive terminal set and the female insulation core. The female conductive terminal set comprises a first female terminal, a second female terminal, a third female terminal, and a fourth female terminal. The female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall. The first female core lateral outer wall and the second female core lateral outer wall extend laterally, while the first female core longitudinal outer wall and the second female core longitudinal outer wall extend longitudinally. The first female core longitudinal outer wall is connected to the first female core lateral outer wall, and the second female core longitudinal outer wall is connected to the second female core lateral outer wall, forming the female core major internal inserting space. The first female core lateral inner wall and the second female core lateral inner wall extend laterally, while the first female core lateral inner wall is connected to the first female core longitudinal outer wall, forming the first female major inserting guiding structure. Additionally, the first female core longitudinal inner wall is connected to the second female core lateral inner wall and the first female core lateral outer wall, forming the second female major inserting guiding structure. The first female major inserting guiding structure and the second female major inserting guiding structure partition the female core major internal inserting space into the first female major internal inserting subspace, the second female major internal inserting subspace, the third female major internal inserting subspace, and the fourth female major internal inserting subspace. The female insulation core is respectively engaged with the first female terminal, the second female terminal, the third female terminal, and the fourth female terminal, ensuring that the first female terminal, the second female terminal, the third female terminal, and the fourth female terminal extend separately into the first female major internal inserting subspace, the second female major internal inserting subspace, the third female major internal inserting subspace, and the fourth female major internal inserting subspace. The first female major internal inserting subspace is in continuity with the second female major internal inserting subspace, the second female major internal inserting subspace is in continuity with the fourth female major internal inserting subspace, and the third female major internal inserting subspace is in continuity with the fourth female major internal inserting subspace. This configuration provides guidance for the insertion of the male connector in the inserting direction, ensuring that the male connector enters the first female major internal inserting subspace, the second female major internal inserting subspace, the third female major internal inserting subspace, and the fourth female major internal inserting subspace, thereby making contact with the first female terminal, the second female terminal, the third female terminal, and the fourth female terminal.

In summary, this application provides a female connector that allows for the insertion of a male connector in the inserting direction. The insulation core of the female connector comprises inserting guiding structures, which provide interference when the male connector is inserted incorrectly in the inserting direction. This prevents the male connector from being inserted into the female connector in the wrong direction, ensuring that the male connector can properly engage with the female connector for power or signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A female connector, wherein the female connector provides inserting of a male connector in an inserting direction, and the female connector comprises:
a female conductive terminal set, wherein the female conductive terminal set comprises a first female terminal, a second female terminal, a third female terminal, and a fourth female terminal; and
a female insulation core, wherein the female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein,
the first female core lateral outer wall and the second female core lateral outer wall laterally extend respectively, and the first female core longitudinal outer wall and the second female core longitudinal outer wall longitudinally extend respectively; the first female core longitudinal outer wall is connected to the first female core lateral outer wall, and the second female core longitudinal outer wall is connected to the second female core lateral outer wall, to form a female core major internal inserting space;
the first female core lateral inner wall and the second female core lateral inner wall laterally extend respectively, wherein the first female core lateral inner wall is connected to the first female core longitudinal outer wall to form a first female major inserting guiding structure, and the first female core longitudinal inner wall is connected to the second female core lateral inner wall and the first female core lateral outer wall respectively to form a second female major inserting guiding structure; wherein,
the first female major inserting guiding structure and the second female major inserting guiding structure partition the female core major internal inserting space into a first female major internal inserting subspace, a second female major internal inserting subspace, a third female major internal inserting subspace, and a fourth female major internal inserting subspace;
the female insulation core is respectively mated with the first female terminal, the second female terminal, the third female terminal, and the fourth female terminal, such that the first female terminal extends into the first female major internal inserting subspace, the second female terminal extends into the second female major internal inserting subspace, the third female terminal extends into the third female major internal inserting subspace, and the fourth female terminal extends into the fourth female major internal inserting subspace; and
the first female major internal inserting subspace is in continuity with the second female major internal inserting subspace, the second female major internal inserting subspace is in continuity with the fourth female major internal inserting subspace, and the third female major internal inserting subspace is in continuity with the fourth female major internal inserting subspace to provide guiding for inserting of the male connector in the inserting direction, such that the male connector enters the first female major internal inserting subspace, the second female major internal inserting subspace, the third female major internal inserting subspace, and the fourth female major internal inserting subspace respectively, thereby respectively inserting into the first female terminal, the second female terminal, the third female terminal, and the fourth female terminal.

2. The female connector of claim 1, wherein the first female major inserting guiding structure comprises a T-shaped cross-section; and the second female major inserting guiding structure comprises an L-shaped cross-section.

3. The female connector of claim 1, wherein the first female core lateral inner wall and the first female core longitudinal outer wall substantially intersect perpendicularly, and the second female core lateral inner wall and the first female core longitudinal inner wall substantially intersect perpendicularly.

4. The female connector of claim 1, wherein the female insulation core comprises a lateral extension plane, the first female core lateral inner wall and the second female core lateral inner wall extend respectively on the lateral extension plane, and the lateral extension plane substantially intersects perpendicularly with the first female core longitudinal outer wall and the first female core longitudinal inner wall.

5. The female connector of claim 1, wherein the female conductive terminal set further comprises a fifth female terminal and a sixth female terminal, and the female insulation core further comprises a third female core longitudinal outer wall and a third female core lateral inner wall, wherein the third female core longitudinal outer wall longitudinally extends and is respectively connected to the first female core lateral outer wall and the second female core lateral outer wall, such that the second female core longitudinal outer wall, the third female core longitudinal outer wall, the first female core lateral outer wall, and the second female core lateral outer wall form a female core minor internal inserting space;
the third female core lateral inner wall is connected to the second female core longitudinal outer wall or the third female core longitudinal outer wall to form a first female minor inserting guiding structure; wherein,
the first female minor inserting guiding structure partitions the female core minor internal inserting space into a first female minor internal inserting subspace and a second female minor internal inserting subspace;
the female insulation core is further mated with the fifth female terminal and the sixth female terminal, such that the fifth female terminal extends into the first female minor internal inserting subspace, and the sixth female terminal extends into the second female minor internal inserting subspace; and
the first female minor internal inserting subspace is in continuity with the second female minor internal inserting subspace to provide guiding for inserting of the male connector in the inserting direction, such that the male connector enters the first female minor internal inserting subspace and the second female minor internal inserting subspace respectively, thereby respectively inserting into the fifth female terminal and the sixth female terminal.

6. The female connector of claim 5, wherein the first female minor inserting guiding structure comprises a T-shaped cross-section.

7. The female connector of claim 5, wherein the third female core lateral inner wall and the second female core longitudinal outer wall or the third female core longitudinal outer wall substantially intersect perpendicularly.

8. The female connector of claim 5, wherein the female insulation core comprises a lateral extension plane, the first female core lateral inner wall, the second female core lateral inner wall, and the third female core lateral inner wall extend respectively on the lateral extension plane, and the lateral extension plane substantially intersects perpendicularly with the first female core longitudinal outer wall, the first female core longitudinal inner wall, the second female core longitudinal outer wall, and the third female core longitudinal outer wall.
